(19) United States
(12) Patent Application Publication
(10) Pub. No.: US 2024/0418439 A1
(43) Pub. Date: Dec. 19, 2024

(54) DRYING KILN FOR LUMBER

(71) Applicant: SHUQUALAK LUMBER COMPANY INC., Shuqualak, MS (US)

(72) Inventor: David Earl JONES, Starkville, MS (US)

(21) Appl. No.: 18/742,323

(22) Filed: Jun. 13, 2024

Related U.S. Application Data
(60) Provisional application No. 63/508,127, filed on Jun. 14, 2023.

(51) Int. Cl. F26B 3/04; F26B 15/00; F26B 21/02

(52) U.S. Cl. CPC F26B 3/04; F26B 15/00; F26B 21/02; F26B 2210/16

(57) ABSTRACT

A drying kiln for lumber includes a kiln housing. The kiln housing includes a roof, a plurality of side walls supporting the roof above ground and cooperating with the roof to define kiln interior. The kiln interior includes a drying chamber. The drying kiln further includes a lumber drying system configured to dry lumber within the kiln interior.

### PRIORITY CLAIM

This application claims benefit of co-pending U.S. provisional patent application No. 63/508,127, filed Jun. 14, 2023, entitled DRYING KILN FOR LUMBER, the disclosure of which is incorporated by reference in its entirety herein.

### FIELD

The present disclosure relates, in exemplary embodiments, to lumber drying devices and methods.

### BACKGROUND

Lumber may be treated and dried prior to being used in construction, for example. Lumber can be dried in an oven or kiln. The kiln may heat the lumber using one or more heating elements. As the lumber is heated, moisture may be released from the lumber. Drying lumber in a kiln can require a high energy input and complex systems for controlling humidity in the kiln during the during process.

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to the more detailed description below.

Generally described, the present disclosure provides, in a first exemplary embodiment, a drying kiln for lumber. The drying kiln may include a kiln housing. The kiln housing may include a roof, a plurality of side walls supporting the roof above ground and cooperating with the roof to define kiln interior, and a plurality of interior partition walls located within the kiln interior. The plurality of interior partition walls may to divide the kiln interior into a green-lumber conditioning chamber, a dry-lumber conditioning chamber, and a drying chamber between the green-lumber conditioning chamber and the dry-lumber conditioning chamber.

In illustrative embodiments, the drying kiln may further include a conveyor configured to transport lumber through the green-lumber conditioning chamber, the drying chamber, and the dry-lumber conditioning chamber. The conveyor may transport the lumber continuously and/or in series through the green-lumber conditioning chamber, the drying chamber, and the dry-lumber conditioning chamber.

In illustrative embodiments, the drying kiln may further a lumber drying system. The lumber drying system may include a plurality of primary steam coils located in the drying chamber and configured to heat the lumber to a drying temperature in the drying chamber. The lumber drying system may further include a plurality of air-circulation fans configured to circulate air through the lumber in the green-lumber conditioning chamber. The lumber drying system may further include a plurality of pre-heating steam coils located in the green-lumber chamber and configured to heat the lumber in the green-lumber chamber to a pre-heated temperature less than the drying temperature prior to the lumber entering the drying chamber.

According to another exemplary embodiment in accordance with the present disclosure, a drying kiln for lumber includes a kiln housing formed to include a green-lumber conditioning chamber, a dry-lumber conditioning chamber, and a drying chamber between the green-lumber conditioning chamber and the dry-lumber conditioning chamber. The drying kiln may further include a conveyor configured to transport lumber through the green-lumber conditioning chamber, the drying chamber, and the dry-lumber conditioning chamber.

In illustrative embodiments, the drying kiln further includes a lumber drying system. The drying system may include a plurality of primary heating elements located in the drying chamber and configured to heat the lumber to a drying temperature in the drying chamber. The lumber drying system may further include a plurality of pre-heating elements located in the green-lumber chamber and configured to heat the lumber in the green-lumber chamber to a pre-heated temperature less than the drying temperature prior to the lumber entering the drying chamber.

Another exemplary embodiment, in accordance with the present disclosure, includes a method for drying lumber. The method may include advancing green lumber into an interior of a kiln housing along a conveyor. The method may further include advancing the green lumber through a green-lumber conditioning chamber located within the interior of the kiln housing. The method may further include pre-heating the green lumber in the green-lumber conditioning chamber to a first temperature to provide pre-heated lumber.

In illustrative embodiments, the method may further include advancing the pre-heated lumber from the green-lumber conditioning chamber to a drying chamber located within the kiln housing. The method may further include heating the pre-heated lumber in the drying chamber to a second temperature greater than the first temperature to provide fully-heated lumber. The method may further include circulating air around and through the lumber in the drying chamber.

In illustrative embodiments, the method may further include advancing the fully-heated lumber from the drying chamber to a dry-lumber conditioning chamber. The method may further include circulating air around and through the lumber in the dry-lumber conditioning chamber to provide dry lumber. The method may further include advancing the dry lumber along the conveyor out of the interior of the kiln housing.

Other features will become apparent upon reading the following detailed description of certain exemplary embodiments, when taken in conjunction with the appended claims.

### BRIEF DESCRIPTION OF THE DRAWINGS

The drawings disclose exemplary embodiments in which like reference characters designate the same or similar parts throughout the figures of which:

FIG. 1 is a perspective view of one exemplary embodiment of a lumber-drying kiln in accordance with the present disclosure.

FIG. 2 is a side elevation view of the lumber-drying kiln with a sidewall of the lumber-drying kiln removed to show that the lumber-drying kiln includes a kiln interior having various sub-spaces, each of which has a particular function for drying the lumber during a drying process.

FIG. 3 is a top plane view of the lumber-drying kiln with a roof of the kiln removed to show the kiln interior from an overhead view of the lumber-drying kiln.

FIG. 4 is a front elevation view of the lumber-drying kiln with a front wall of the kiln removed to show the kiln interior from a front end of the lumber-drying kiln.

### DETAILED DESCRIPTION

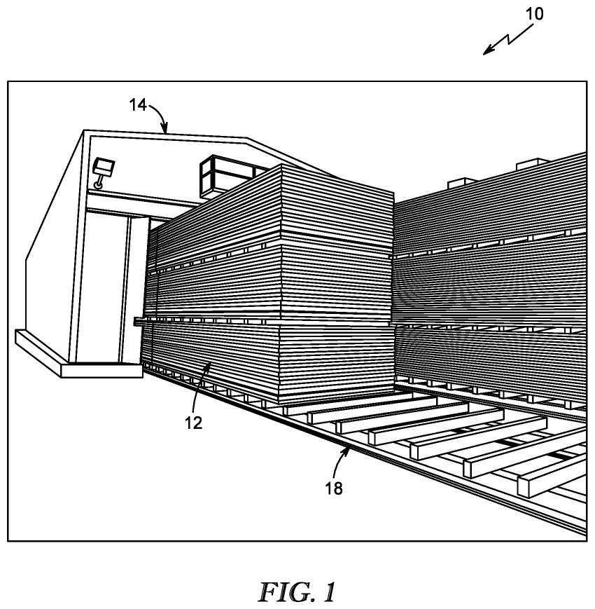

One exemplary embodiment of a drying kiln 10 is shown in FIG. 1 and is configured to dry (i.e., remove moisture from) lumber 12. The drying kiln 10 includes a kiln housing 14 defining a kiln interior 16, a conveyor 18 configured to transport the lumber 12 through the kiln interior 16, and a lumber drying system 20 configured to remove moisture from the lumber 12 during a drying process as the lumber 12 travels through the kiln interior 16 along the conveyor 18. The drying system 20 is configured to control one or more of temperature, humidity, and airflow throughout the kiln interior 16 so that a predetermined amount of moisture is removed from the lumber 12 during the drying process.

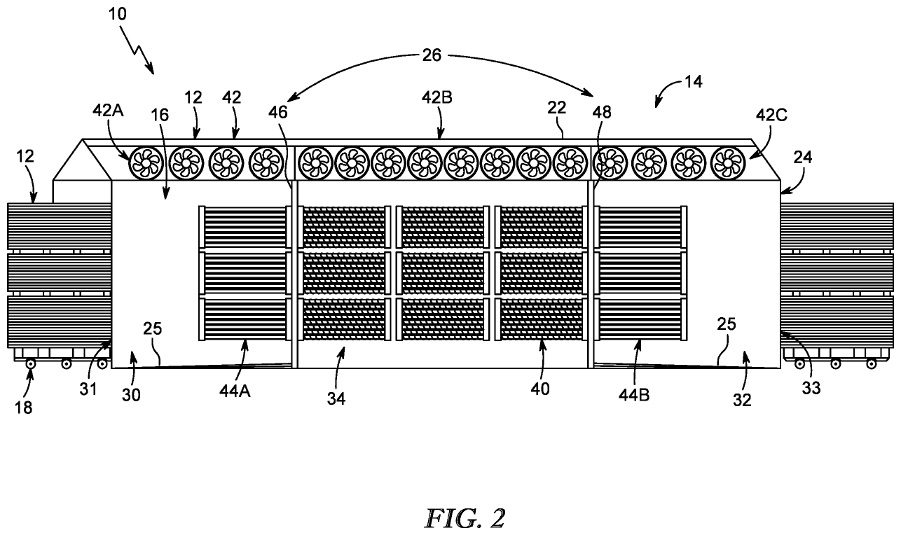

The kiln housing 14 includes a roof 22, a plurality of side walls 24 supporting the roof 22 above ground, and cooperating with the roof to define the kiln interior 16, and a plurality of interior partition walls 26 located within the kiln interior 16 as shown in FIGS. 2-4. The roof 22 provides an overhead barrier for the kiln housing 14 to keep falling environmental elements (i.e., rain, snow, ice, etc.) out of the kiln interior 16. The plurality of side walls 24 extend between and interconnect the roof 22 and the ground and/or a foundation 25 separating the ground and the side walls 24. In the illustrative embodiment, the plurality of side walls 24 includes four side walls 24A, 24B, 24C, 24D. Two opposing side walls 24A, 24C are formed to include a lumber entrance/exit port 31, 32. The conveyor 18 extends between the two lumber ports 31, 33 to carry the lumber 12 therebetween. The plurality of interior partition walls 26 are configured to divide the kiln interior 16 into various sub-spaces, each of which has a particular function for drying the lumber 12 during the drying process. The kiln housing 14 further includes a foundation 25 that is sloped to direct moisture removed from the lumber 12 that falls on the foundation 25 out of the entrance/exit ports 31, 33.

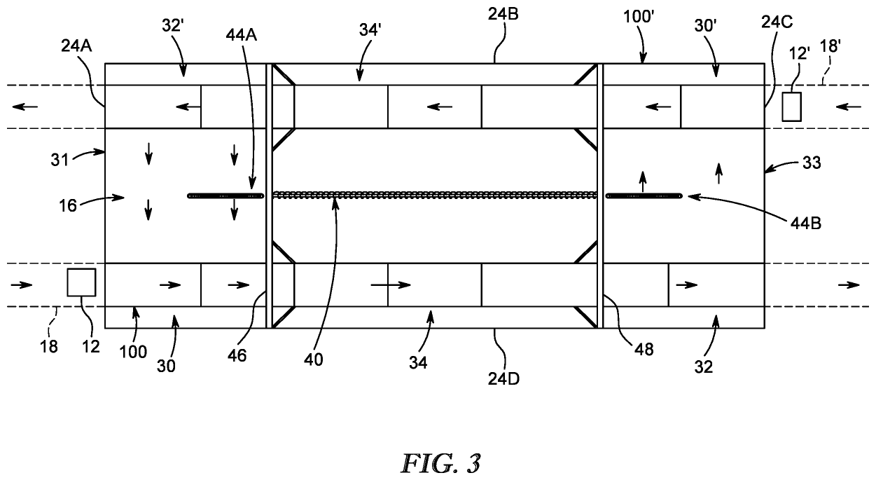

The plurality of interior partition walls 26 extend vertically upward away from the ground with the side walls 24 within the kiln interior 16 to provide a green-lumber conditioning chamber 30, a dry-lumber conditioning chamber 32, and a drying chamber 34 as shown in FIGS. 2 and 3. The conveyor 18 is configured to transport the lumber 12, continuously and in series, through the green-lumber conditioning chamber 30, the drying chamber 34, and the dry-lumber conditioning chamber 32 during the drying process. The conveyor 18 may stop movement of the lumber 12 in one or more of the chambers 30, 32, 34 for a period of time during the drying process. The green-lumber conditioning chamber 30 is located furthest upstream within the kiln interior 16. The dry-lumber conditioning chamber 32 is located furthest downstream within the kiln interior 16. The drying chamber 34 is located between the green-lumber conditioning chamber 30 and the dry-lumber conditioning chamber 32.

The drying system 20 controls heat, humidity, and air circulation in the entire kiln interior 16 to dry the lumber 12 as the lumber 12 is transferred by the conveyor 18 through each chamber 30, 32, 34 as shown in FIGS. 1-4. The drying system 20 includes a plurality of primary steam coils 40 located in the drying chamber 34, a plurality of air circulation fans 42, and a plurality of pre-heating steam coils 44 located in the green-lumber conditioning chamber 30. The plurality of primary steam coils 40 are configured to heat the lumber 12 to a drying temperature in the drying chamber 30. The plurality of air-circulation fans 42 are configured to circulate air around and through the lumber 12 in the green-lumber conditioning chamber 30, the drying chamber 34, and the dry-lumber conditioning chamber 32. The plurality of pre-heating steam coils 44 are located in the green-lumber conditioning chamber 30 and are configured to pre-heat the lumber 12 in the green-lumber conditioning chamber 30 to a pre-heated temperature less than the drying temperature prior to the lumber 12 entering the drying chamber 30 to increase drying efficiencies and throughput rate of the lumber drying kiln 10.

The plurality of interior partition walls 26 include a first partition wall 46 at least partially separating the green-lumber conditioning chamber 30 and the drying chamber 34 and a second partition wall 48 at least partially separating the dry-lumber conditioning chamber 32 from the drying chamber 34 as shown in FIG. 3. The plurality of primary steam coils 40 are arranged to lie solely within the drying chamber 34 between the first and second partition walls 46, 48. The plurality of primary steam coils 40 are configured to radiate heat produced from hot steam circulating through the coils. In some embodiments, steam may also be released toward or in the vicinity of the lumber 12. The plurality of pre-heating steam coils 44 are substantially similar in form and function to the primary steam coils 40, but are located solely in the green-lumber conditioning chamber 30 on an opposite side of the first partition wall 46 from the primary steam coils 40 as shown in FIG. 3. In some embodiments, the plurality of pre-heating steam coils 44 are fluidly connected to the plurality of primary steam coils 40 to receive and reuse the steam or heated fluid flowing through the plurality of primary steam coils 40. In this way, power consumption of the drying kiln 10 and/or the lumber-drying system 20 may be reduced. The plurality of air circulation fans 42 are configured to circulate the air through each chamber 30, 32, 34 in the kiln interior 16, including the heat and/or steam, through and around the lumber 12 to remove moisture and dry the lumber 12 as shown in FIGS. 2 and 3.

Although the plurality of primary steam coils 40 and the plurality of pre-heating steam coils 44 are steam coils in the illustrative embodiment, in other embodiments, any suitable heating element may be used. Additionally, if a different heating element is used, the drying kiln 10 may include a separate system for adding steam into the kiln interior 16 to regulate the humidity of the kiln interior 16 to control the release of moisture from the lumber 12.

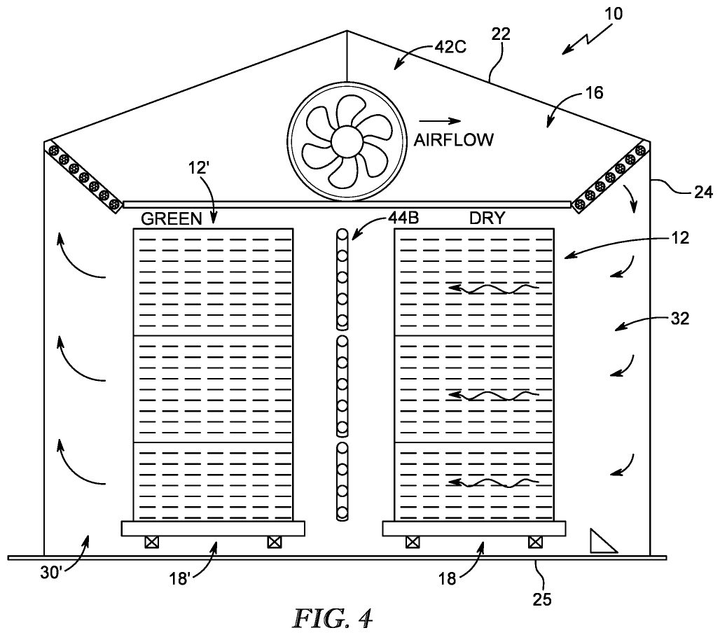

In the illustrative embodiment, the drying kiln 10 includes two continuous drying lines 100, 100′ positioned on opposite lateral sides of the kiln interior 16 as shown in FIGS. 3 and 4. Each drying line 100, 100′ includes its own conveyor 18, 18′ which transport separate lumber stacks 12, 12′ in opposite directions to one another through the kiln interior 16. The lumber 12, 12′ travels continuously and in series through the green-lumber conditioning chamber 30, 30′, the drying chamber 34, 34′, and the dry-lumber conditioning chamber 32, 32′.

The plurality of air circulation fans 42 direct the flow of air to establish the green-lumber conditioning chamber 30, 30′, the drying chamber 34, 34′, and the dry-lumber conditioning chamber 32, 32′ for each of the drying lines 100, 100′ as shown in FIGS. 3 and 4. The plurality of air-circulation fans 42 are positioned above each of the chambers and extend generally in a line below the roof 22 and between the entrance/exit ports 31, 33. The plurality of air-circulation fans 42 includes a first set of fans 42A located between side wall 24A and first partition wall 46, a second set of fans 42B located between the first partition wall 46 and the second partition wall 48, and a third set of fans 42C located between the second partition wall 48 and side wall 24C. The first set of fans 42A are oriented to move air toward the green lumber 12 entering the entrance/exit port 31 in the first drying line 100 and away from the dry lumber exiting entrance/exit port 31 in the second drying line 100′. The second set of fans 42B are configured to move air uniformly throughout the drying chamber 30, 30′ in both drying lines 100, 100′. The third set of fans 42C are oriented to move air toward the green lumber 12′ entering the entrance/exit port 33 in the second drying line 100′ and away from the dry lumber exiting entrance/exit port 33 in the first drying line 100.

The plurality of primary steam coils 40 are arranged to lie laterally between each drying line 100, 100′ to provide each drying chamber 34, 34′ on each lateral side of the plurality of primary steam coils 40 as shown in FIG. 3. The second set of fans 42B evenly distributes air and heat generated by the plurality of primary steam coils 40 to the lumber 12, 12′ in both drying lines 100, 100′ to dry the lumber 12, 12′ in each line 100, 100′ at the same time.

The plurality of pre-heating steam coils 44 include a first set of pre-heating steam coils 44A arranged to lie between side wall 24A and first partition wall 46 and a second set of pre-heating steam coils 44B located between the second partition wall 48 and side wall 24C. The first set of fans 42A is configured to move air in a circular motion within the kiln interior to pass first through the dry lumber 12′ in the second drying line 100′, then through the first set of pre-heating coils 44A, and then through the green lumber 12 in the first drying line 100. Likewise, the third set of fans 42C is configured to move air in a circular motion to pass first through the dry lumber 12 in the first drying line 100, then through the second set of pre-heating coils 44B, and then through the green lumber 12′ in the second drying line 100′. These air motions both distribute moisture though the drying lumber 34, 34 in each drying line 100, 100′ and move heat from the pre-heating coils 44 though the green lumber in each drying line 100, 100′ to pre-heat the green lumber 12, 12′ before entering the drying chamber 34, 34′. In this way, the pre-heating steam coils 44 increase efficiencies and throughput rate of the drying kiln 10. This motion also at least partially cools the dry lumber in the dry-lumber conditioning chamber 32, 32′ before exiting the kiln interior 16 to further expedite the drying process. It should be noted that the plurality of air circulation fans 42 can be arranged anywhere in the chambers 30, 30′, 32, 32′, 34, 34′ to affect this air movement relative to the lumber 12, 12′ traveling through the kiln interior 16.

The present disclosure also provides methods for drying lumber. One exemplary embodiment of a method for drying lumber comprise advancing green lumber into the kiln interior 16 of the kiln housing 14 along and/or with the conveyor 18. The method may further include advancing the green lumber through the green-lumber conditioning chamber 30 located within the interior 16 of the kiln housing 14. The method may further include pre-heating the green lumber in the green-lumber conditioning chamber 30 to a first temperature to provide pre-heated lumber. The method may further include advancing the pre-heated lumber from the green-lumber conditioning chamber 30 to the drying chamber 34 located within the kiln housing 16. The method may further include heating the pre-heated lumber in the drying chamber 34 to a second temperature greater than the first temperature to provide fully-heated lumber. The method may further include circulating air around and through the lumber in the drying chamber 34. The method may further include advancing the fully-heated lumber from the drying chamber 34 to the dry-lumber conditioning chamber 32. The method may further include circulating air around and through the lumber in the dry-lumber conditioning chamber 32 to provide dry lumber. The method may further include advancing the dry lumber along the conveyor 18 out of the interior 16 of the kiln housing 14.

Unless otherwise indicated, the drawings are intended to be read (for example, cross-hatching, arrangement of parts, proportion, degree, or the like) together with the specification, and are to be considered a portion of the entire written description of this invention. As used in the following description, the terms “horizontal”, “vertical”, “left”, “right”, “up” and “down”, “upper” and “lower” as well as adjectival and adverbial derivatives thereof (for example, “horizontally”, “upwardly”, or the like), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

Although only a number of exemplary embodiments have been described in detail above, those skilled in the art will readily appreciate that many modifications are possible in the exemplary embodiments without materially departing from the novel teachings and advantages. Accordingly, all such modifications are intended to be included within the scope of this disclosure as defined in the following claims.

While the methods, equipment and systems have been described in connection with specific embodiments, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used in the specification and the appended claims the singular forms “a,” “an”, and “the” include plural referents unless the context clearly dictates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods, equipment and systems. These and other components are disclosed herein, and it is understood that when combinations, subsets, interactions, groups, etc., of these components are disclosed that while specific reference of each various individual and collective combinations and permutation of these may not be explicitly disclosed, each is specifically contemplated and described herein, for all methods, equipment and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

It should further be noted that any patents, applications and publications referred to herein are incorporated by reference in their entirety.

What is claimed is:

1. A drying kiln for lumber, comprising:
a) a kiln housing including a roof, a plurality of side walls supporting the roof above ground and cooperating with the roof to define kiln interior, and a plurality of interior partition walls located within the kiln interior to divide the kiln interior into a green-lumber conditioning chamber, a dry-lumber conditioning chamber, and a drying chamber between the green-lumber conditioning chamber and the dry-lumber conditioning chamber;
b) a conveyor configured to transport lumber, continuously and in series, through the green-lumber conditioning chamber, the drying chamber, and the dry-lumber conditioning chamber; and,
c) a lumber drying system comprising
i) a plurality of primary steam coils located in the drying chamber and configured to heat the lumber to a drying temperature in the drying chamber,
ii) a plurality of air-circulation fans configured to circulate air through the lumber in the green-lumber conditioning chamber,
iii) the drying chamber,
iv) the dry-lumber conditioning chamber, and
v) a plurality of pre-heating steam coils located in the green-lumber chamber and configured to heat the lumber in the green-lumber chamber to a pre-heated temperature less than the drying temperature prior to the lumber entering the drying chamber.

2. The drying kiln of claim 1, wherein the plurality of preheating steam coils are coupled to the plurality of primary steam coils to receive steam therefrom after the steam flows through the plurality of primary steam coils.

3. The drying kiln of claim 1, wherein the plurality of air circulation fans circulate air in a direction that pushes the air in a first direction first thorough the plurality of pre-heating steam coils and then to the lumber.

4. The drying kiln of claim 3, wherein the drying system further includes a second set of air circulation fans configured to circulate air through the drying chamber and a third set of air circulation fans configured to circulate air through the dry-lumber conditioning chamber.

5. The drying kiln of claim 4, wherein the second set of air circulation fans are oriented to circulate air in the first direction through the plurality of primary steam coils and then toward the lumber in the drying chamber and the third set of air circulation fans are oriented to circulate air in a second direction opposite the first direction.

6. The drying kiln of claim 1, wherein the drying kiln includes a first drying line configured to dry a first stack of lumber and extending through the green-lumber conditioning chamber, the drying chamber, and the dry-lumber conditioning chamber and a second drying line configured to dry a second stack of lumber and extending through a second green-lumber conditioning chamber, the drying chamber, and a second dry-lumber conditioning chamber.

7. The drying kiln of claim 6, wherein the plurality of pre-heating steam coils are located between the green-lumber conditioning chamber of the first drying line and the dry-lumber conditioning chamber of the second drying line and the drying system further includes a second plurality of pre-heating steam coils located between the second green-lumber conditioning chamber of the second drying line and the dry-lumber conditioning chamber of the first drying line.

8. The drying kiln of claim 7, wherein the plurality of air-circulation fans are oriented to circulate air in a first direction to travel from the plurality of pre-heating steam coils toward the first stack of lumber in the green-lumber conditioning chamber and away from the second stack of lumber, and the drying system further includes a second plurality of air circulation fans oriented to circulate air in a second direction opposite the first direction to travel from the second plurality of pre-heating steam coils toward the second stack of lumber in the second green-lumber conditioning chamber and away from the first stack of lumber.

9. A drying kiln for lumber, comprising:
a) a kiln housing formed to include a green-lumber conditioning chamber, a dry-lumber conditioning chamber, and a drying chamber between the green-lumber conditioning chamber and the dry-lumber conditioning chamber;
b) a conveyor configured to transport lumber through the green-lumber conditioning chamber, the drying chamber, and the dry-lumber conditioning chamber; and
c) a lumber drying system comprising
i) a plurality of primary heating elements located in the drying chamber and configured to heat the lumber to a drying temperature in the drying chamber, and
ii) a plurality of pre-heating elements located in the green-lumber chamber and configured to heat the lumber in the green-lumber chamber to a pre-heated temperature less than the drying temperature prior to the lumber entering the drying chamber.

10. The drying kiln of claim 9, wherein the plurality of pre-heating elements are coupled to the plurality of primary heating elements to receive heat therefrom after the heat flows through the plurality of primary heating elements.

11. The drying kiln of claim 10, wherein the drying system further comprises a plurality of air circulation fans configured to circulate air in a first direction that pushes the air in a first direction first thorough the plurality of pre-heating elements and then to the lumber.

12. The drying kiln of claim 11, wherein the drying system further includes a second set of air circulation fans configured to circulate air through the drying chamber and a third set of air circulation fans configured to circulate air through the dry-lumber conditioning chamber.

13. The drying kiln of claim 12, wherein the second set of air circulation fans are oriented to circulate air in the first direction through the plurality of primary heating elements and then toward the lumber in the drying chamber and the third set of air circulation fans are oriented to circulate air in a second direction opposite the first direction.

14. The drying kiln of claim 9, wherein the drying kiln includes a first drying line configured to dry a first stack of lumber and extending through the green-lumber conditioning chamber, the drying chamber, and the dry-lumber conditioning chamber and a second drying line configured to dry a second stack of lumber and extending through a second green-lumber conditioning chamber, the drying chamber, and a second dry-lumber conditioning chamber.

15. The drying kiln of claim 14, wherein the plurality of pre-heating elements are located between the green-lumber conditioning chamber of the first drying line and the dry-lumber conditioning chamber of the second drying line and the drying system further includes a second plurality of pre-heating elements located between the second green-lumber conditioning chamber of the second drying line and the dry-lumber conditioning chamber of the first drying line.

16. The drying kiln of claim 15, wherein the plurality of air-circulation fans are oriented to circulate air in a first direction to travel from the plurality of pre-heating elements toward the first stack of lumber in the green-lumber conditioning chamber and away from the second stack of lumber, and the drying system further includes a second plurality of air circulation fans oriented to circulate air in a second direction opposite the first direction to travel from the second plurality of pre-heating elements toward the second stack of lumber in the second green-lumber conditioning chamber and away from the first stack of lumber.

17. A method for drying lumber, comprising steps of:
a) advancing green lumber into an interior of a kiln housing along a conveyor;
b) advancing the green lumber through a green-lumber conditioning chamber located within the interior of the kiln housing;
c) pre-heating the green lumber in the green-lumber conditioning chamber to a first temperature to provide pre-heated lumber;
d) advancing the pre-heated lumber from the green-lumber conditioning chamber to a drying chamber located within the kiln housing;
e) heating the pre-heated lumber in the drying chamber to a second temperature greater than the first temperature to provide fully-heated lumber;
f) circulating air around and through the lumber in the drying chamber;
g) advancing the fully-heated lumber from the drying chamber to a dry-lumber conditioning chamber;
h) circulating air around and through the lumber in the dry-lumber conditioning chamber to provide dry lumber; and
i) advancing the dry lumber along the conveyor out of the interior of the kiln housing.

18. The method of claim 17, wherein the step of pre-heating the green lumber in the green-lumber conditioning chamber includes circulating heated air in a first direction from a plurality of pre-heating elements toward the green lumber.

19. The method of claim 17, wherein the step of advancing the green lumber includes advancing a first stack of green lumber through the pre-heating conditioning chamber in a first direction and advancing a second stack of green lumber through a second pre-heating conditioning chamber in a second direction, different than the first direction, and the method further includes pre-heating the second stack of green lumber in the second green-lumber conditioning chamber to the first temperature to provide a second stack of pre-heated lumber.

20. The method of claim 19, further comprising steps of:
heating the second stack of pre-heated lumber in the drying chamber to the second temperature greater than the first temperature to provide a second stack of fully-heated lumber;
circulating air around and through the second stack of fully-heated lumber in the drying chamber;
advancing the second stack of fully-heated lumber from the drying chamber to a second dry-lumber conditioning chamber;
circulating air around and through the second stack of fully-heated lumber in the second dry-lumber conditioning chamber to provide a second stack of dry lumber; and
advancing the second stack of dry lumber out of the interior of the kiln housing.
